(19) United States
(12) Patent Application Publication
(10) Pub. No.: US 2015/0363118 A1
(43) Pub. Date: Dec. 17, 2015

(54) TECHNIQUES FOR HARMONIC-RESISTANT FILE STRIPING

(71) Applicant: NETAPP, INC., Sunnyvale, CA (US)

(72) Inventor: Richard JERNIGAN, Pittsburgh, PA (US)

(73) Assignee: NETAPP, INC., Sunnyvale, CA (US)

(21) Appl. No.: 14/306,506

(22) Filed: Jun. 17, 2014

(51) Int. Cl. G06F 3/06

(52) U.S. Cl. CPC G06F 3/0613; G06F 3/0643; G06F 3/067

(57) ABSTRACT

Techniques for harmonic-resistant file striping are described. In one embodiment, for example, an apparatus may comprise a processor circuit and a storage medium comprising instructions for execution by the processor circuit to receive a request to write data to a file at a specified offset, determine a stripe identifier (ID) based on the specified offset according to a harmonic-resistant striping order, and initiate a write procedure to cause the data to be written to a stripe of the file, the stripe corresponding to the stripe ID. Other embodiments are described and claimed.

### BACKGROUND

File striping is a technique that may be implemented in a data storage system in order to balance input/output (I/O) load among storage nodes, and to increase the achievable throughput with which data can be provided to clients that request it. The striping of any particular file may generally involve storing logically sequential segments of the file in different respective storage locations, each of which may comprise a respective “stripe” of the file. While the I/O load associated with client access to an un-striped file may be borne entirely by the physical storage node housing the un-striped file, the I/O load associated with access to a striped file may be shared by a plurality of physical storage nodes in which stripes for the striped file are distributed.

### BRIEF DESCRIPTION OF THE DRAWINGS

FIG. 1 illustrates an embodiment of an operating environment.

FIG. 2 illustrates an embodiment of a first striped file layout.

FIG. 3 illustrates an embodiment of a second striped file layout.

FIG. 4 illustrates an embodiment of an apparatus and an embodiment of a system.

FIG. 5 illustrates an embodiment of a first logic flow.

FIG. 6 illustrates an embodiment of a third striped file layout.

FIG. 7 illustrates an embodiment of a second logic flow.

FIG. 8 illustrates an embodiment of a third logic flow.

FIG. 9 illustrates an embodiment of a storage medium.

FIG. 10 illustrates an embodiment of a computing architecture.

FIG. 11 illustrates an embodiment of a communications architecture.

### DETAILED DESCRIPTION

Various embodiments are directed to techniques for harmonic-resistant file striping. In one embodiment, for example, an apparatus may comprise a processor circuit and a storage medium comprising instructions for execution by the processor circuit to receive a request to write data to a file at a specified offset, determine a stripe identifier (ID) based on the specified offset according to a harmonic-resistant striping order, and initiate a write procedure to cause the data to be written to a stripe of the file, the stripe corresponding to the stripe ID. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

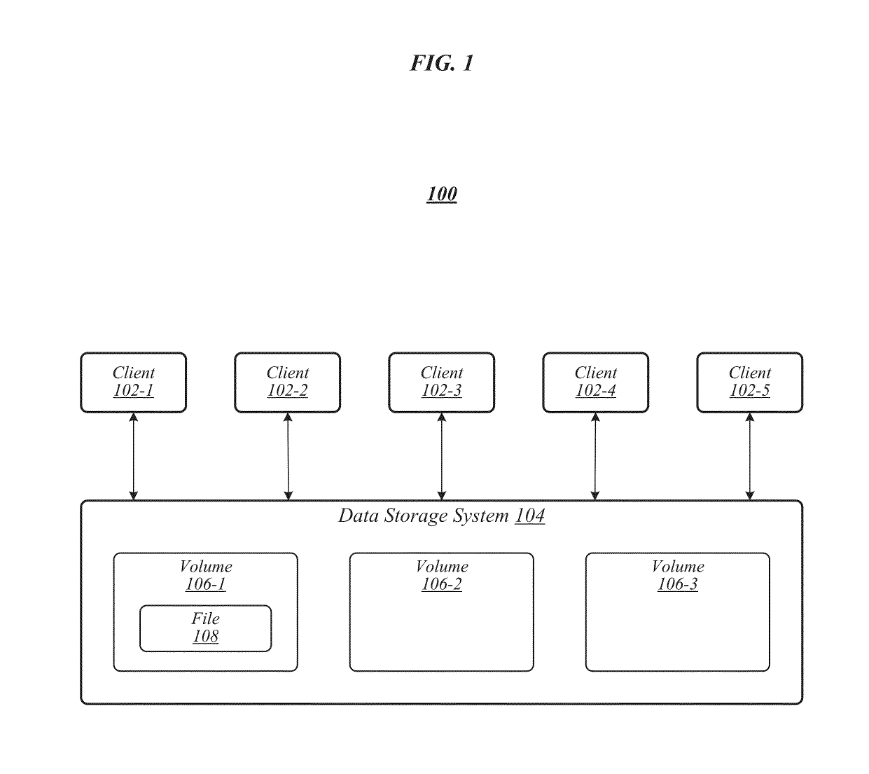

FIG. 1 illustrates an example of an operating environment 100 such as may be representative of various embodiments. As shown in FIG. 1, in operating environment 100, a plurality of clients 102 may access and/or communicate with a data storage system 104. Examples of data storage system 104 may include, without limitation, a network-attached storage system and a storage area network. In some embodiments, a plurality of logical volumes 106 may be defined that correspond to physical storage resources of data storage system 104. In the example of FIG. 1, data storage system 104 comprises volumes 106-1, 106-2, and 106-3. In various embodiments, data storage system 104 may comprise a storage cluster made up of a plurality of interconnected storage nodes, and the plurality of volumes 106 may be distributed across the plurality of interconnected storage nodes.

In operating environment 100, volume 106-1 contains a file 108. In some embodiments, data storage system 104 may be designed such that at any particular point in time, any or all of clients 102 may be permitted to access file 108 concurrently. In various embodiments, data storage system 104 may additionally or alternatively be designed such that any particular client 102 may be permitted to access multiple portions of file 108 concurrently via parallel input/output (I/O) processes. In some embodiments, the collective throughput demanded by clients 102 attempting concurrent access to file 108 may exceed the collective throughput according to which data storage system 104 is capable of servicing their access requests. For example, in various embodiments, the collective demanded throughput associated with access to file 108 may exceed the achievable throughput of a data node comprising a portion of volume 106-1 that is used to store file 108. In some embodiments, the larger file 108 becomes, the more likely that achievable throughput may be exceeded.

In various embodiments, data storage system 104 may implement a file striping scheme in order to increase achievable throughput for large files and/or to reduce the tendency of large files to subject individual nodes and/or volumes to increased I/O loads. According to such a scheme, files that grow beyond a threshold size may be logically partitioned into multiple portions (“stripes”), and those stripes may be stored in a fashion that distributes their associated I/O among multiple nodes and/or volumes. For example, if file 108 grows beyond a threshold size, which may also be referred to as “stripe width,” defined by a file striping scheme of data storage system 104, then file 108 may be logically partitioned into a first stripe corresponding to data storage blocks of volume 106-1 and a second stripe corresponding to data storage blocks of volume 106-2.

In some embodiments, a file striping scheme for data storage system 104 may be defined in conjunction with levels of indirection associated with a file system for data storage system 104. In various embodiments, data storage system 104 may utilize a file system that defines, for each volume 106, a set of index nodes (“inodes”) that comprise indirect references to the actual data blocks of that volume. For example, in some embodiments, data storage system 104 may utilize a write-anywhere file layout (WAFL). In various embodiments, partitioning file 108, may, according to the file striping scheme, be partitioned into multiple inodes, each comprising a stripe of file 108. In some embodiments, the multiple inodes may correspond to different respective volumes. In an example embodiment, a single inode of volume 106-1 may initially comprise file 108, which may initially be smaller than the stripe width. Subsequently, file 108 may grow to be larger than the stripe width. At this point, file 108 may be partitioned into a first stripe comprised in an inode of volume 106-1 and a second stripe comprised in an inode of volume 106-2. The embodiments are not limited to this example.

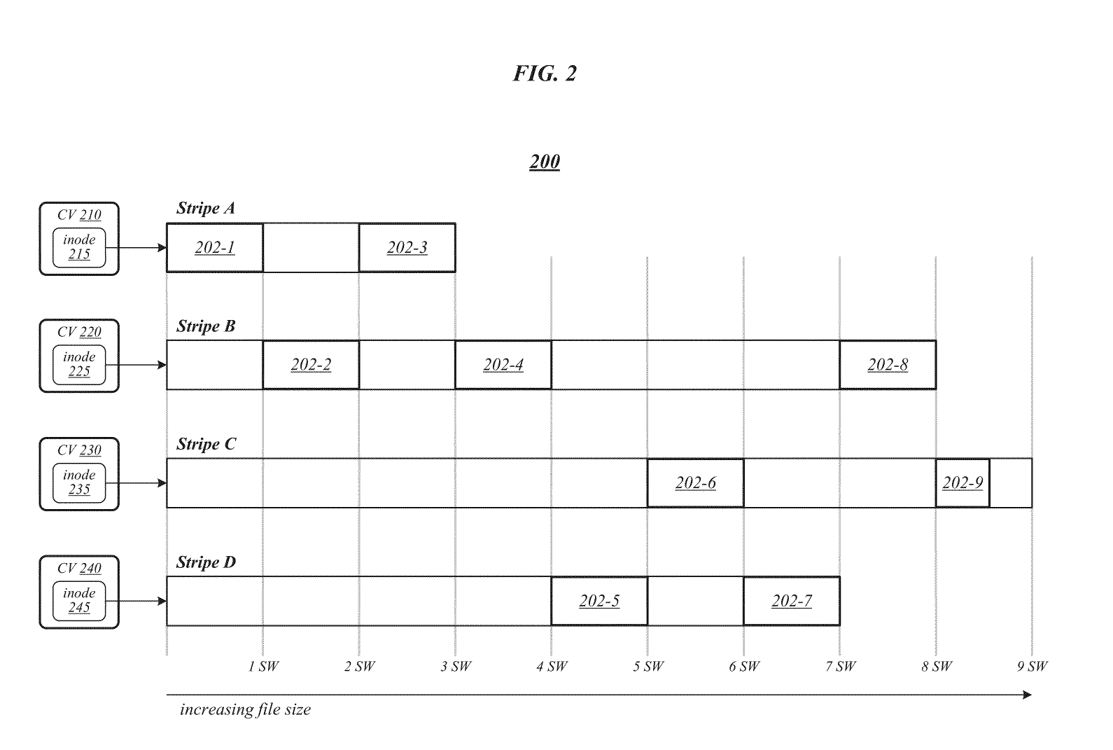

FIG. 2 illustrates a striped file layout 200 such as may be representative of various embodiments. In the example of FIG. 2, various portions 202 of a file are distributed among four stripes, each of which corresponds to a respective inode. Stripe A corresponds to an inode 215 of a container volume 210, and comprises file portions 202-1 and 202-3. Stripe B corresponds to an inode 225 of a container volume 220, and comprises file portions 202-2, 202-4, and 202-8. Stripe C corresponds to an inode 235 of a container volume 230, and comprises file portions 202-6 and 202-9. Stripe D corresponds to an inode 245 of a container volume 240, and comprises file portions 202-5 and 202-7. The arrangement of the stored file of FIG. 2 into file portions 202 that are distributed among multiple stripes may enable the realization of improved throughput when multiple clients wish to access the file concurrently. In an example embodiment, three clients may concurrently access the file, each from a respective random or pseudo-random starting position. If the first client begins with file portion 202-6 in stripe C, the second client begins with file portion 202-2 in stripe B, and the third client begins with file portion 202-5 in stripe D, then their collective access will involve concurrent, parallel communications with three container volumes, rather than concurrent communication with a single container volume. As a result, a throughput improvement may be achieved with respect to throughput limitations that may be associated with concurrent access by all three clients to the same container volume. The embodiments are not limited to this example.

In some embodiments, striped file layout 200 may result from the application of a file striping scheme as the file comprising the file portions 202 grows. For example, the file may initially be less than one stripe width (“SW”) in size, may subsequently grow to beyond one stripe width in size, and may then be partitioned into file portions 202-1 and 202-2 based on the file striping scheme. Continuing with this example, the file may then increase to beyond two stripe widths in size, and file portion 202-3 may be created to accommodate the data blocks of the file that follow the first two stripe widths of data blocks. This process may continue on an ongoing basis, with each successive stripe width of data of the file being stored as a respective file portion 202 within one of stripes A-D. In the example of FIG. 2, the file has surpassed eight stripe widths in length, and ends with a file portion 202-9 that fills part of a ninth stripe width.

In some embodiments, striped file layout 200 may be representative of a striping order defined by a file striping scheme. In various embodiments, the striping order may specify an order according to which the various stripes A-D are to be used to store the various file portions 202. In some embodiments, such a striping order may be specified by a striping table, in which each value designates a stripe to be used to store a respective file portion. For example, in various embodiments, striped file layout 200 may be generated in accordance with a striping table that specifies that the first nine file portions of the file are to be stored in stripes A, B, A, B, D, C, D, B, and C, respectively. It is to be appreciated that with respect to the term “striping table” as used herein, the word “table” is employed in a generic sense to refer to any ordered set of elements. As such, in various embodiments, examples of a striping table may include, without limitation, a pre-computed list, array, matrix, table, or any other logical representation of an ordered set of elements that defines an order according to which stripes are to be used, or an algorithm that computes the order dynamically. In some embodiments, any particular striping order may be reflective of a maximum number of stripes to be used to contain a file, and may define an order according to which file portions are to be stored among that number of stripes. For example, striped file layout 200 may be generated in accordance with a striping order that specifies an order according to which file portions 202 are to be stored among a maximum of four stripes. The embodiments are not limited to this example.

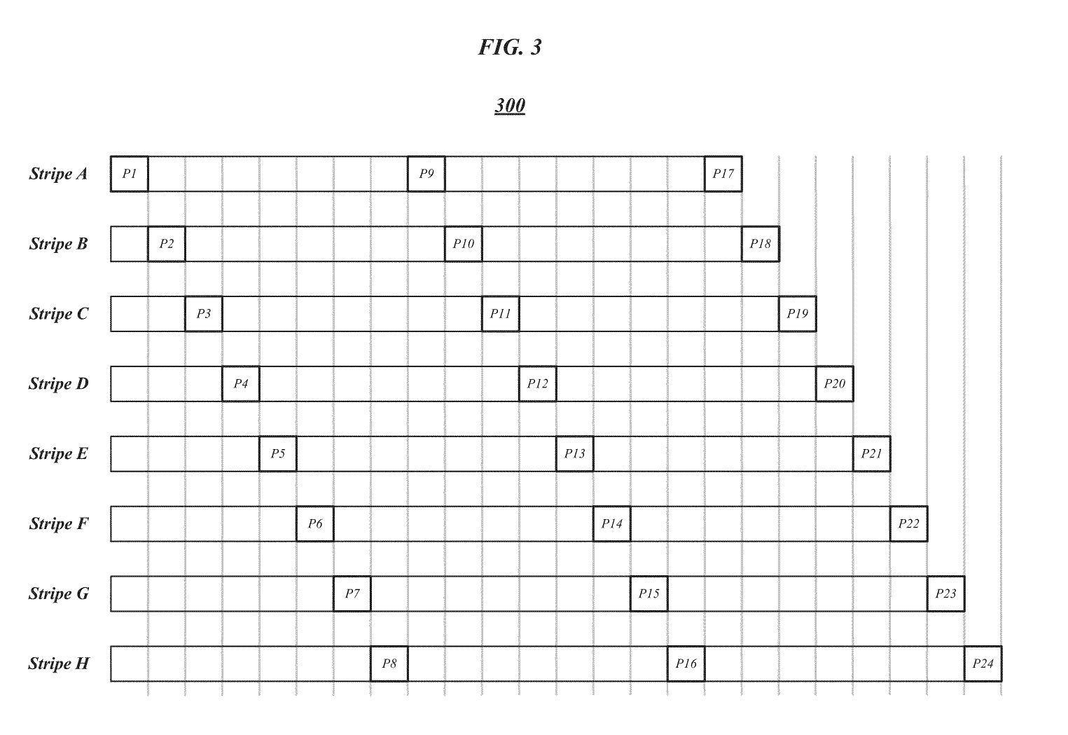

FIG. 3 illustrates a striped file layout 300 that may be generated in accordance with a striping order corresponding to a specified maximum of eight stripes. More particularly, striped file layout 300 may be representative of a simple striping order according to which storage of file portions is cycled through eight stripes A-H. In striped file layout 300, file portion P1 is stored in stripe A, file portion P2 is stored in stripe B, file portion P3 is stored in stripe C, and so forth, until each stripe contains one file portion. When it becomes necessary to store file portion P9, the cycle restarts, and file portion P9 is stored in stripe A. In the example of FIG. 3, striped file layout ultimately comprises a total of twenty-four file portions P1-P24, which are sequentially stored among the eight stripes A-H.

Any particular client that accesses the file comprised in striped file layout 300 may do so by sequentially accessing the file portions P1-P24. In some cases, the client may begin its sequential access from a randomly or pseudo-randomly selected starting position. Each time a client finishes accessing a given file portion in a given stripe, it may transition to accessing a next file portion in a next stripe. For example, once a client finishes accessing file portion P3 in stripe C, it may transition to accessing file portion P4 in stripe D. A noteworthy property of striped file layout 300 is that for any given stripe, the transition is always to a same next stripe, regardless of which file portion has been accessed. For example, from stripe F, access always transitions to stripe G, regardless of whether the completed access has been to file portion P6, P14, or P22.

One potential drawback associated with this property may be that it may render the file vulnerable to file access harmonics. File access harmonics generally connote the tendency of latency at a given stripe to cause a bottleneck that upsets an initially even distribution of accesses to the various portions of the file. In an illustrative example embodiment, there may initially be a same or approximately same number of respective clients accessing each of file portions P1-P24 in striped file layout 300 in conjunction with sequential access to the striped file comprising those file portions P1-P24. At a time T₁, a hardware issue may temporarily reduce the achievable throughput associated with access to stripe D and/or its corresponding container volume. At a time T2, the clients that were accessing file portions P3, P11, and P19 in stripe C may complete their access, and begin attempting to access file portions P4, P12, and P20, respectively, in stripe D. However, because of the aforementioned reduced throughput associated with access to stripe D, the clients that were accessing its file portions at time T₁ may not yet have completed their access at time T2. As a result, beginning at time T2, there may be twice as many clients accessing stripe D as there were before, which may further reduce the throughput for stripe D. The further reduced throughput may contribute to the development of an even more pronounced bottleneck, resulting in yet more throughput reduction, and this effect may progress to the point that a substantial majority of the clients, or even all of the clients, are concurrently accessing stripe D while the remaining stripes are idle or virtually idle. Furthermore, because file portions P4, P12, and P20 are succeeded by respective file portions P5, P13, and P21 that all reside in stripe E, the bottleneck at stripe D may tend to propagate to stripe E, and subsequently to each successive stripe of striped file layout 300. Because the transitions from any given stripe of striped file layout 300 will always be to a single respective other stripe, the bottleneck may persist and pass from stripe to stripe indefinitely.

Disclosed herein are techniques for harmonic-resistant file striping that may negate or reduce this effect in various embodiments. According to some such techniques, a harmonic-resistant striping order may be defined, according to which the transitions from each stripe are evenly or approximately evenly distributed among the remaining stripes. In various embodiments, a harmonic-resistant striping table may be generated that specifies the harmonic-resistant striping order. In some embodiments, the harmonic-resistant striping table may be generated using a harmonic-resistant striping table generation algorithm. The embodiments are not limited in this context.

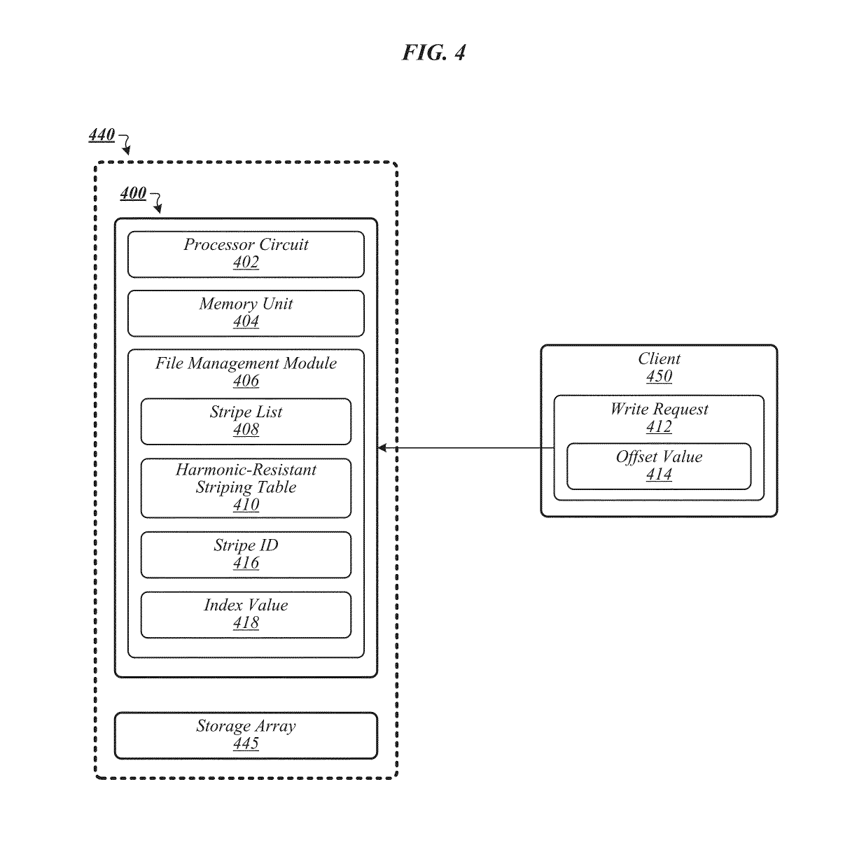

FIG. 4 illustrates a block diagram of an apparatus 400 that may implement improved harmonic-resistant file striping techniques in various embodiments. Apparatus 400 may be representative of a data node such as may be comprised in data storage system 104 of FIG. 1 in some embodiments. As shown in FIG. 4, apparatus 400 comprises multiple elements including a processor circuit 402, a memory unit 404, and an auditing subsystem 406. The embodiments, however, are not limited to the type, number, or arrangement of elements shown in this figure.

In various embodiments, apparatus 400 may comprise processor circuit 402. Processor circuit 402 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 402 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. The embodiments are not limited in this context.

In some embodiments, apparatus 400 may comprise or be arranged to communicatively couple with a memory unit 404. Memory unit 404 may be implemented using any machine-readable or computer-readable media capable of storing data, including both volatile and non-volatile memory. For example, memory unit 404 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy of note that some portion or all of memory unit 404 may be included on the same integrated circuit as processor circuit 402, or alternatively some portion or all of memory unit 404 may be disposed on an integrated circuit or other medium, for example a hard disk drive, that is external to the integrated circuit of processor circuit 402. Although memory unit 404 is comprised within apparatus 400 in FIG. 4, memory unit 404 may be external to apparatus 400 in various embodiments. The embodiments are not limited in this context.

In some embodiments, apparatus 400 may comprise a file management module 406. File management module 406 may comprise logic, circuitry, and/or instructions operative to manage and/or facilitate the storage of—and/or access to—one or more files of a storage system comprising apparatus 400. In various embodiments, file management module 406 may comprise and/or implement a file system for the storage system. In some embodiments, for example, file management module 406 may comprise and/or implement a WAFL for the storage system. In various embodiments, the file system may define one or more levels of indirection that are applicable to file storage and/or access. In some embodiments, for example, file management module 406 may comprise and/or implement a file system according to which, for each volume of the storage system, a set of inodes is defined that comprise indirect references to the actual data blocks of that volume. In various embodiments, file management module 406 may be operative to manage and/or facilitate the storage of—and/or access to—one or more files on one or more local storage devices. In some embodiments, file management module 406 may additionally or alternatively be operative to manage and/or facilitate the storage of—and/or access to—one or more files on one or more remote storage devices. The embodiments are not limited in this context.

FIG. 4 also illustrates a block diagram of a system 440. System 440 may comprise any of the aforementioned elements of apparatus 400. System 440 may further comprise a storage array 445. Storage array 445 may comprise a set of physical storage devices, such as a set of hard disks and/or tape devices, and some or all of the storage resources of those physical storage devices may be allocated among one or more volumes. In various embodiments, file management module 406 may be operative to manage and/or facilitate the storage of—and/or access to—one or more files on one or more volumes on storage array 445. The embodiments are not limited in this context.

In some embodiments, file management module 406 may be operative to define, manage, and/or implement a file striping scheme for use in conjunction with storage of files in the storage system. In various embodiments, for a given striped file, file management module 406 may be operative to create, maintain, and/or update a stripe list 408. In some embodiments, the stripe list 408 may comprise information identifying the respective storage locations associated with each of the stripes used by the file. In various embodiments, the stripe list 408 may comprise information identifying, for each stripe used by the file, a stripe identifier (ID) and a corresponding volume and/or inode that contains that stripe. In some embodiments, the stripe list 408 may comprise file handles that identify inodes containing the stripes of the file. In various embodiments, the stripe list 408 may itself be contained in an inode, and clients may reference the striped file by identifying a public file handle that corresponds to that inode. The embodiments are not limited in this context.

In some embodiments, file management module 406 may be operative to generate, identify, and/or implement a harmonic-resistant striping order for the striped file. More particularly, in various embodiments, file management module 406 may be operative to generate and/or utilize a harmonic-resistant striping table 410 that defines such a harmonic-resistant striping order. In some embodiments, the harmonic-resistant striping table 410 may comprise a static array of integers, each corresponding to a stripe of the striped file. In various embodiments, according to the harmonic-resistant striping order, for each stripe of the striped file, the access transitions may be evenly or approximately evenly distributed among the remaining stripes. In some embodiments, the harmonic-resistant striping order may reflect a maximum number of stripes that may be used to store the striped file. In various embodiments, according to the harmonic-resistant striping order, the initial portions of the striped file may be confined to a smaller number of stripes. In some embodiments, additional stripes may be allocated for the striped file at periodic file size intervals as the striped file grows. In various embodiments, after a particular file size interval threshold is reached and new stripes are allocated for the striped file, the file striping order may initially route a disproportionately large fraction of newly created portions of the striped file to the new stripes, in order to move towards an even or approximately even distribution of the file across the newly expanded set of stripes.

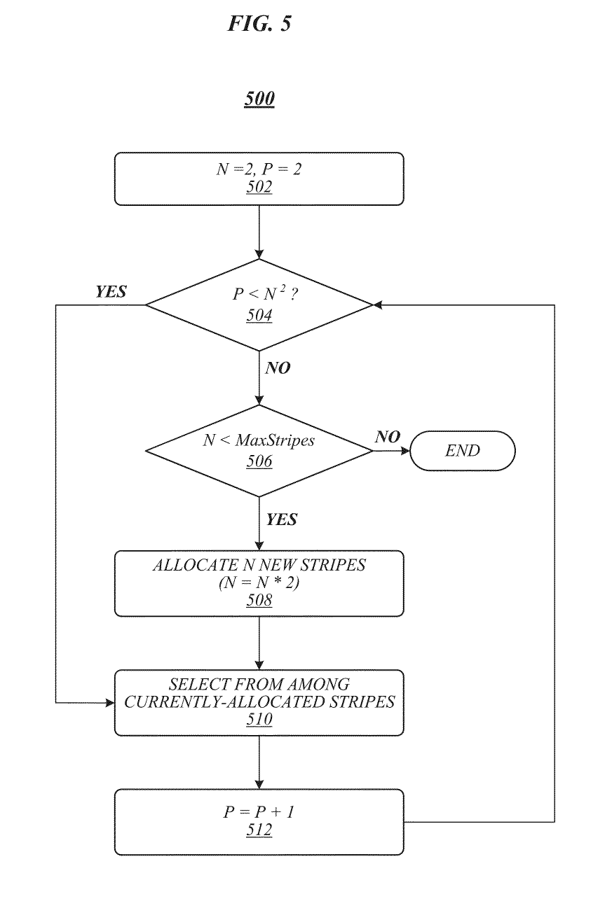

FIG. 5 illustrates an embodiment of a logic flow 500 such as may be representative of an algorithm for determining size thresholds at which to allocate new stripes for a striped file as that striped file grows. In some embodiments, harmonic-resistant striping table 410 of FIG. 4 may define a striping order that implements such size thresholds. As shown in FIG. 5, logic flow 500 may begin at 502, where a variable N representing a number of currently-allocated file stripes and a variable P representing a number of currently-allocated file portions may both be set equal to 2. At 504, it may be determined whether P is less than N². If it is determined at 504 that P is not less than N², flow may pass to 506. At 506, it may be determined whether N is less than a MaxStripes parameter that defines the maximum number of stripes that may be allocated according to the algorithm embodied in logic flow 500. If it is determined at 506 that N is not less than MaxStripes, the logic flow may end. If it is determined at 506 that N is less than MaxStripes, flow may pass to 508. At 508, a number of new stripes may be allocated that is equal to the number of currently allocated stripes N. In order to reflect the allocation of these new stripes, the value of N may then be doubled.

From 508, flow may pass to 510, where a stripe in which to store a next file portion may be selected from among the currently allocated stripes, which may now include those that were newly allocated at 508. If it is determined at 504 that P is less than N², then flow may pass directly to 510. Following the selection of the stripe in which to store the next file portion at 510, flow may pass to 512, where the value of P may be incremented. From 512, flow may return to 504, where the incremented value of P may be considered. This cycle may continue until the value of N reaches MaxStripes and the value of P reaches MaxStripes², at which point the determinations at 504 and 506 will cause the logic flow to end.

It is worthy of note that according to the algorithm embodied in logic flow 500, each time new stripes are allocated, the total number of stripes is doubled. In other words, each time new stripes are allocated, the number of newly allocated stripes is equal to the number of previously allocated stripes. One advantage associated with this property in various embodiments may be that a disproportionately large fraction of new file portions may be assigned to the new stripes without causing an excessive performance burden. It is also worthy of note that according to this algorithm, any particular number N of currently allocated stripes will be used to hold N² file portions before any new stripes are allocated. For example, the first two allocated stripes will be used to hold the first four file portions, the first four allocated stripes will be used to hold the first sixteen file portions, and so forth. One advantage associated with these properties in some embodiments may be that not only may the number of allocated stripes automatically increase as the file size increases, but also the usage levels of each stripe may automatically increase as the number of distinct inter-stripe transitions increases. Other advantages may be associated with various embodiments, and the embodiments are not limited in this context.

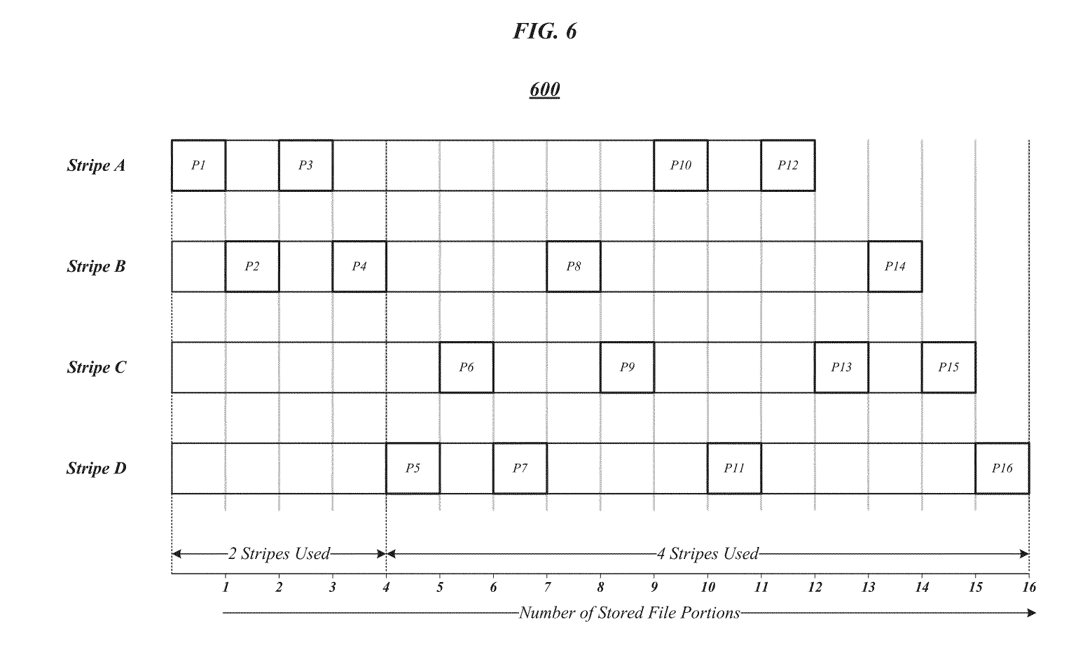

FIG. 6 illustrates a striped file layout 600 such as may be representative of some embodiments. More particularly, striped file layout 600 may comprise an example of a striped file layout resulting from the implementation of a harmonic-resistant striping order such as may be defined by harmonic-resistant striping table 410 of FIG. 4. Striped file layout 600 may also comprise an example of a striped file layout that observes file size thresholds such as may be specified by the algorithm of FIG. 5. The embodiments are not limited in this context.

In striped file layout 600, a file has grown to a size of sixteen stripe widths, and is thus partitioned into sixteen file portions P1-P16. The numbering of these file portions corresponds to the order in which the data that they contain is added to the file. Thus, for example, file portions P1 and P2 comprise the first two stripe widths of data that were added to the file. Two stripes A and B are used to store the first four file portions P1-P4, a property which may reflect the determination at 504 in FIG. 5, according to which new stripes are not allocated until the number of stored file portions equals the square of the current number of stripes. Correspondingly, beginning with file portion P5, two newly allocated stripes C and D are used along with pre-existing stripes A and B to store new file portions.

A noteworthy property of striped file layout 600 is that the transitions from each particular stripe are approximately evenly distributed among the respective remaining stripes, and each stripe transitions to each other stripe at least once. For example, from stripe A, there are two transitions to stripe B (from P1 to P2 and from P3 to P4), one transition to stripe C (P12 to P13), and one transition to stripe D (P10 to P11). In various embodiments, as a result of the approximately even transition distribution that it exhibits, striped file layout 600 may be resistant to file access harmonics. For example, even if a hardware malfunction or other issue causes I/O load to be entirely or almost entirely concentrated at a single stripe at a particular point in time, the fact that the transitions from that stripe are distributed across the remaining stripes may help mitigate the problem by dividing the load among the remaining stripes. The embodiments are not limited to this example.

Another noteworthy property of striped file layout 600 is that following the allocation of new stripes C and D, a disproportionately large fraction of the new file portions are stored in stripes C and D. Of the first five file portions that are stored following the allocation of stripes C and D, two (P6 and P9) are stored in stripe C and two (P5 and P7) are stored in stripe D. In some embodiments, by initially favoring new stripes for storage of new file portions, the file striping order that underlies striped file layout 600 may more quickly achieve an even or approximately even distribution of the file across the newly expanded set of stripes. The embodiments are not limited in this context.

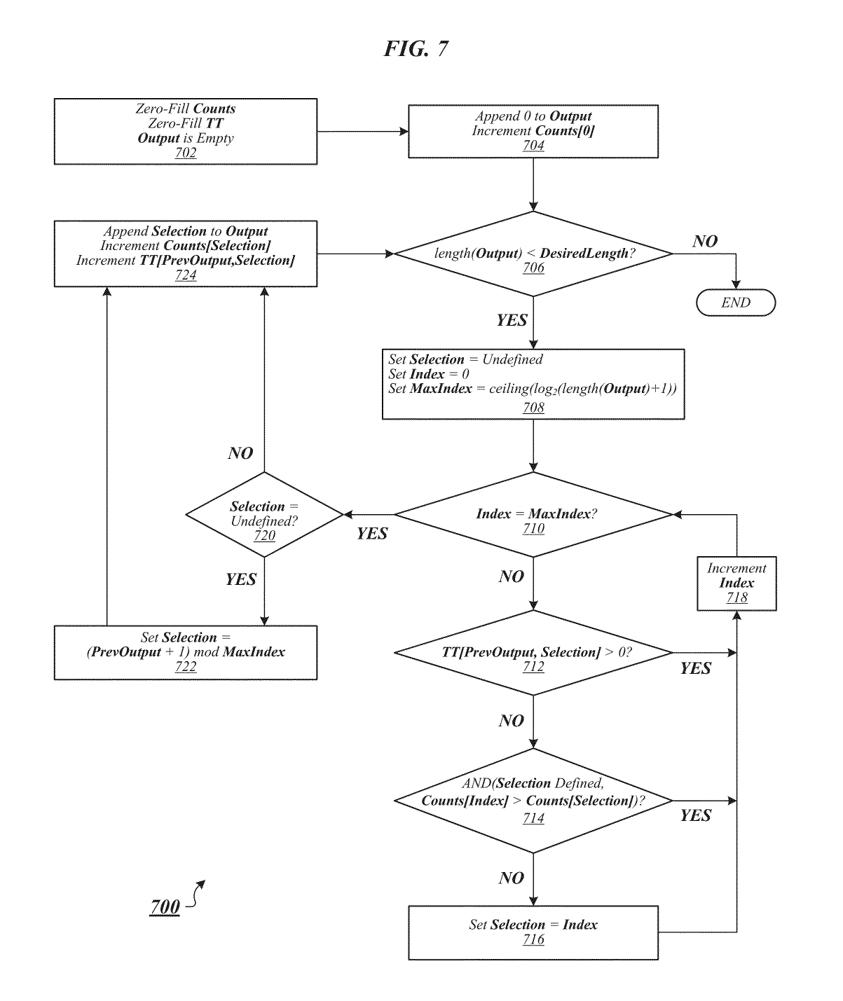

FIG. 7 illustrates an embodiment of a logic flow 700 such as may be representative of a harmonic-resistant striping table generation algorithm. In various embodiments, file management module 406 of FIG. 4 may be operative to employ such a harmonic-resistant striping table generation algorithm in order to generate harmonic-resistant striping table 410. In some embodiments, a MaxStripes parameter may comprise an input parameter for logic flow 700, and may specify a maximum number of stripes that may be used by a harmonic-resistant striping table that is generated using logic flow 700. Counts may comprise an integer variable array of length MaxStripes. For each stripe of the harmonic-resistant striping table, Counts may be used to maintain a respective tally indicating the number of file portions that have been assigned to that stripe. TransitionTable (TT) may comprise a two-dimensional (2-D) integer variable array of length MaxStripes and width MaxStripes. For each stripe of the harmonic-resistant striping table, TT may be used to maintain a set of respective tallies indicating the respective total numbers of transitions from that stripe to each of the other stripes of the harmonic-resistant striping table. Output may comprise a variable-length integer array, and each integer that is added to Output may comprise or represent a stripe ID. At 702, Counts and TT may be zero-filled, and Output may be initialized as an empty integer array. At 704, a “0” may be appended to Output, and Counts[0] may be incremented.

A DesiredLength parameter may comprise an integer specifying a desired number of file portions to be accommodated by a harmonic-resistant striping table that is generated using logic flow 700. At 706, it may be determined whether this desired number of file portions has been reached. Since each element in Output may designate a stripe for storage of a respective file portion, this determination may be performed by comparing the length of Output to DesiredLength. If the length of Output is not less than DesiredLength, this may indicate that the desired number of accommodated file portions has been reached, and the logic flow may end. If the length of Output is less than DesiredLength, indicating that the desired number of accommodated file portions has not been reached, flow may pass to 708.

A Selection parameter may comprise a variable used to convey, during each iteration of the iterative process in logic flow 700, a stripe ID that is selected during that iteration. Parameters Index and MaxIndex may comprise integer variables that hold intermediate values based on which navigation within logic flow 700 is performed during each iteration. At 708, Selection may be set to an undefined or null state, Index may be set equal to 0, and MaxIndex may be set equal to an integer value according to Equation (1) as follows:

MaxIndex=ceiling(log₂(length(Output)+1)) (1)

where ceiling(x) represents rounding the value x up to the nearest integer.

At 710, it may be determined whether Index is equal to MaxIndex. If it is determined that Index is not equal to MaxIndex, flow may pass to 712. At 712, it may be determined whether TT[PrevOutput, Selection] is greater than zero. PrevOutput may comprise an integer variable comprising a value equal to that of the stripe ID most recently appended to Output. If it is determined at 712 that TT[PrevOutput, Selection] is greater than zero, flow may pass to 718, where Index may be incremented. If it is determined at 712 that TT[PrevOutput, Selection] is not greater than zero, flow may pass to 714. At 714, it may be determined whether Selection is defined and whether Counts[Index] is greater than Counts[Selection]. If it is determined at 714 that Selection is defined and Counts[Index] is greater than Counts[Selection], flow may pass to 718, where Index may be incremented. If it is determined at 714 that Selection is not defined and/or that Counts[Index] is not greater than Counts[Selection], flow may pass to 716. At 716, Selection may be set equal to Index, and flow may then pass to 718, where Index may be incremented. From 718, flow may return to 710.

The first time it is determined, at 710, that Index is equal to MaxIndex, flow may pass to 720. At 720, it may be determined whether Selection is undefined. If it is determined at 720 that Selection is undefined, flow may pass to 722. At 722, Selection may be set equal to an integer value according to Equation (2) as follows:

Selection=(PrevOutput+1)mod MaxIndex (2)

where A mod B represents the remainder of the Euclidean division of A by B.

From 722, flow may pass to 724. If it is determined at 720 that Selection is not undefined, flow may pass directly to 724. At 724, the value comprised in Selection may be appended to Output, Counts[Selection] may be incremented, and TT[PrevOutput, Selection] may be incremented. Flow may then return to 706, where it may once again be determined whether the desired number of file portions has been reached. The iterative process embodied by elements 706 to 724 may continue until the length of Output reaches DesiredLength, at which point the logic flow may end.

Returning to FIG. 4, in various embodiments, file management module 406 may be operative to generate harmonic-resistant striping table 410 according to a harmonic-resistant striping table generation algorithm such as that embodied in logic flow 700 of FIG. 7. In some embodiments, file management module 406 may be operative to pre-calculate and store harmonic-resistant striping table 410. In various embodiments, file management module 406 may be operative to store harmonic-resistant striping table 410 as a read-only global variable within an operating system that is to service file access requests. In some embodiments, file management module 406 may be operative to implement the operating system that is to service file access requests. In various such embodiments, file management module 406 may also be operative to implement a standalone program, procedure, or routine via which it may generate harmonic-resistant striping table 410. The embodiments are not limited in this context.

In some embodiments, during general operation, apparatus 400 and/or system 440 may be operative to receive a write request 412 that comprises a request to write data to the file associated with stripe list 408. In various embodiments, write request 412 may comprise a request on the part of a client 450. In some embodiments, apparatus 400 and/or system 440 may be operative to receive write request 412 from the client 450 indirectly, via one or more other nodes comprised in the storage system that comprises apparatus 400 and/or system 440. In various other embodiments, apparatus 400 and/or system 440 may be operative to receive write request 412 directly from client 450. The embodiments are not limited in this context.

In some embodiments, write request 412 may comprise an offset value 414. In various embodiments, offset value 414 may comprise a value specifying an offset at which data is to be written to the file. In some embodiments, file management module 406 may be operative to determine a stripe ID 416 based on the offset specified by offset value 414. In various embodiments, file management module 406 may be operative to obtain the stripe ID 416 from harmonic-resistant striping table 410 based on offset value 414. In some embodiments, file management module 406 may be operative to determine an index value 418 based on the offset value 414, and then may be operative to obtain the stripe ID 416 from harmonic-resistant striping table 410 based on the index value 418. In various embodiments, file management module 406 may be operative to obtain the stripe ID 416 from harmonic-resistant striping table 410 by retrieving the element located at the position in harmonic-resistant striping table 410 that corresponds to the index value 418. In some embodiments, file management module 406 may be operative to determine index value 418 according to Equation (3) as follows:

IV=(OV/SW)mod((SC_{MAX})²) (3)

where IV represents index value 418, OV represents offset value 414, SW represents a defined stripe width for application in conjunction with use of harmonic-resistant striping table 410, and SC_{MAX} comprises a maximum stripe count representing a maximum

number of stripes that may be used to store the file in question.

In various embodiments, file management module 406 may be operative to initiate a write procedure to cause data comprised in write request 412 to be written to a stripe corresponding to stripe ID 416. In some embodiments, according to the write procedure, file management module 406 may direct write request 412 to a file handle, inode, and/or volume for a stripe that corresponds to stripe ID 416. In various embodiments, file management module 406 may be operative to access stripe list 408 to determine whether stripe ID 416 corresponds to an already-existing stripe. In some embodiments, if stripe list 408 includes an entry comprising a stripe ID that matches stripe ID 416, file management module 406 may be operative to identify the file handle, inode, and/or volume corresponding to stripe ID 416 based on that entry. In various embodiments, if stripe list 408 does not include an entry comprising a stripe ID that matches stripe ID 416, file management module 406 may be operative to initiate a stripe creation procedure to create a new stripe that corresponds to stripe ID 416. In some embodiments, the stripe creation procedure may involve allocating a file handle, inode, and/or volume for the new stripe and adding a new entry to stripe list 408, the new entry comprising the stripe ID, file handle, inode, and/or volume for the new stripe. The embodiments are not limited in this context.

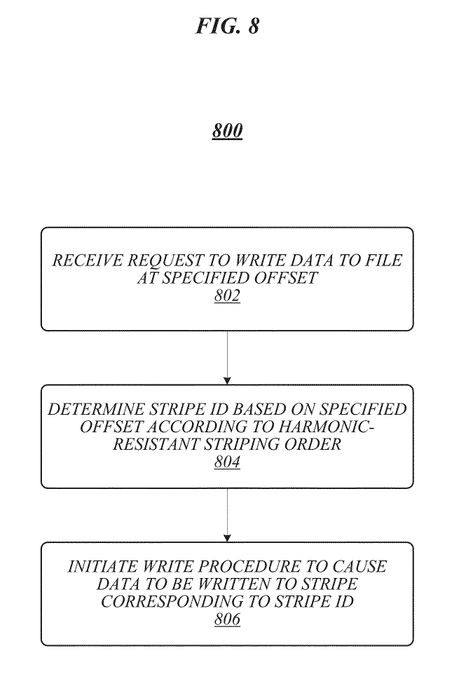

FIG. 8 illustrates a logic flow 800 such as may be representative of various embodiments. For example, logic flow 800 may be representative of operations that may be performed in some embodiments by apparatus 400 and/or system 440 of FIG. 4. As shown in FIG. 8, a request to write data to a file at a specified offset may be received at 802. For example, apparatus 400 and/or system 440 of FIG. 4 may be operative to receive the write request 412 that originates from client 450. At 804, a stripe ID may be determined based on the specified offset, according to a harmonic-resistant striping order. For example, file management module 406 of FIG. 4 may be operative to determine index value 418 based on offset value 414 and to obtain stripe ID 416 from harmonic-resistant striping table 410 using index value 418. At 806, a write procedure may be initiated to cause data to be written to a stripe corresponding to the stripe ID. For example, file management module 406 of FIG. 4 may be operative to initiate a write procedure according to which it identifies a file handle, inode, and/or volume for a stripe corresponding to stripe ID 416 and directs write request 412 to that file handle, inode, and/or volume. The embodiments are not limited to these examples.

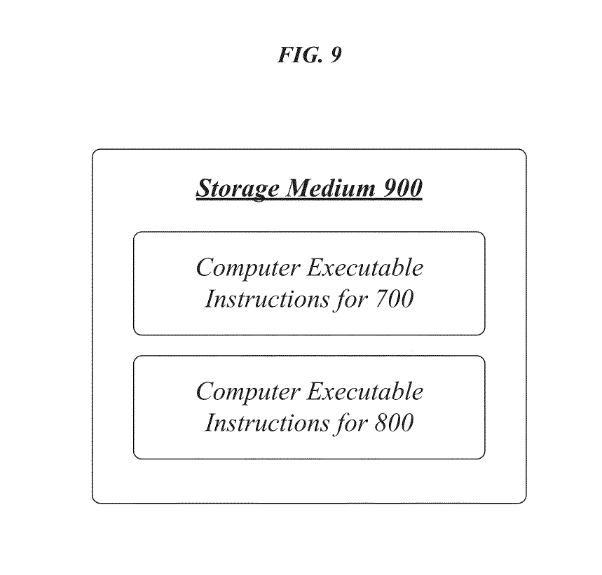

FIG. 9 illustrates an embodiment of a storage medium 900. Storage medium 900 may comprise any non-transitory computer-readable storage medium or machine-readable storage medium, such as an optical, magnetic or semiconductor storage medium. In various embodiments, storage medium 900 may comprise an article of manufacture. In some embodiments, storage medium 900 may store computer-executable instructions, such as computer-executable instructions to implement logic flow 700 of FIG. 7 and/or logic flow 800 of FIG. 8. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

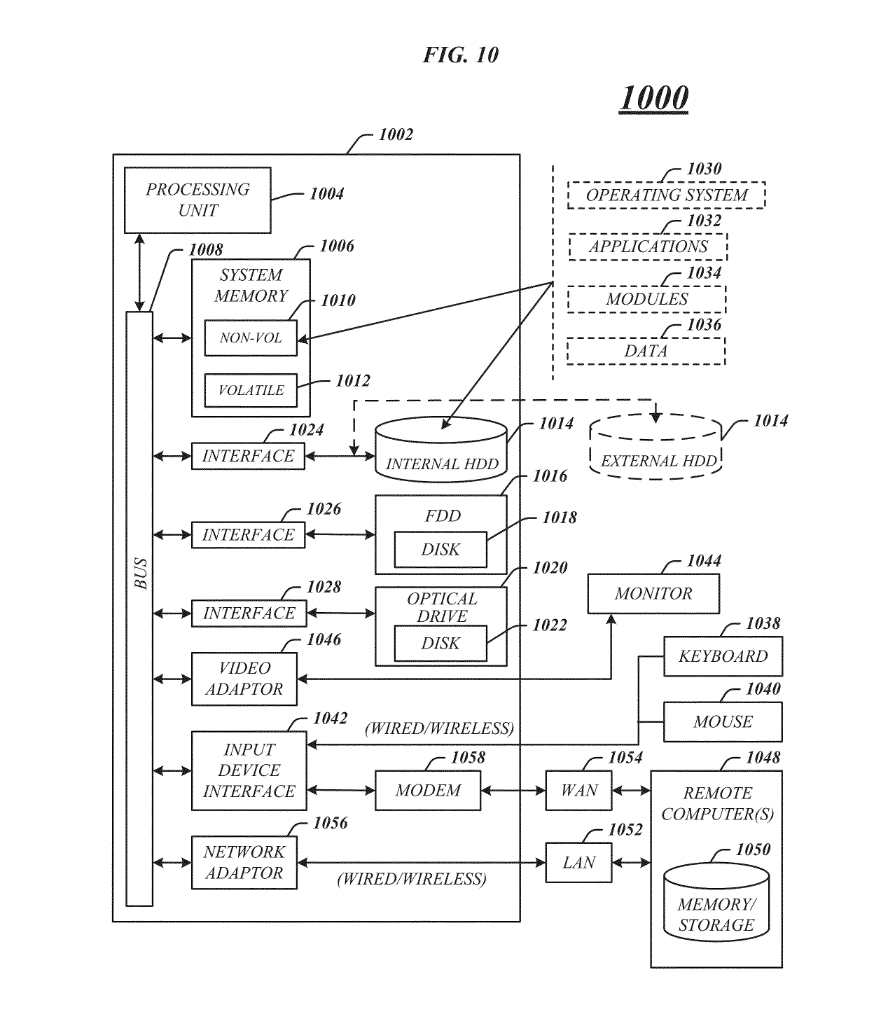

FIG. 10 illustrates an embodiment of an exemplary computing architecture 1000 suitable for implementing various embodiments as previously described. In various embodiments, the computing architecture 1000 may comprise or be implemented as part of an electronic device. In some embodiments, the computing architecture 1000 may be used, for example, to implement apparatus 400 and/or system 440 of FIG. 4, logic flow 700 of FIG. 7, logic flow 800 of FIG. 8, and/or storage medium 900 of FIG. 9. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the apparatus 400 and/or system 440 of FIG. 4.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

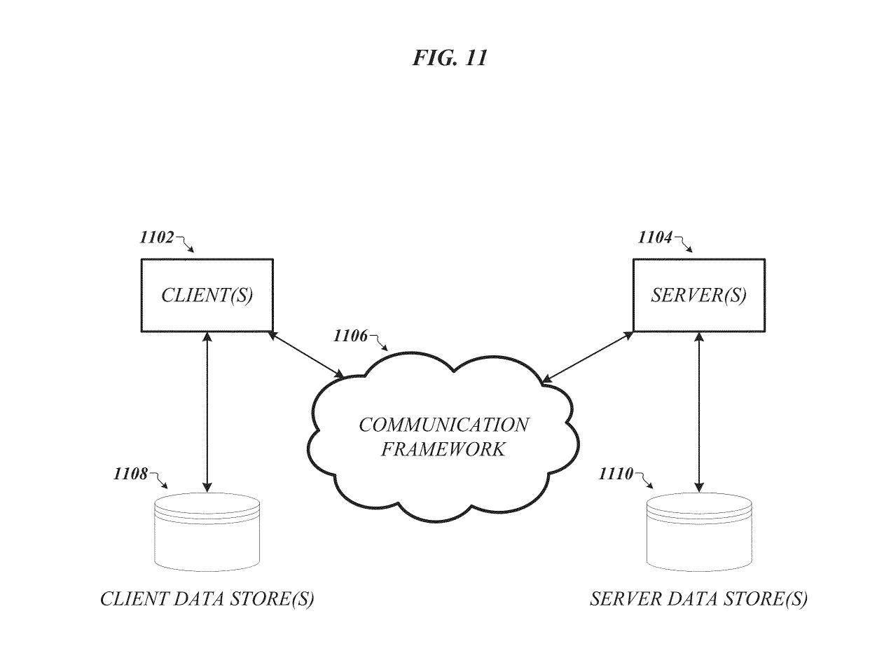

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 and the servers 1104 are operatively connected to one or more respective client data stores 1108 and server data stores 1110 that can be employed to store information local to the respective clients 1102 and servers 1104, such as cookies and/or associated contextual information. Any one of clients 1102 and/or servers 1104 may implement apparatus 400 and/or system 440 of FIG. 4, logic flow 700 of FIG. 7, logic flow 800 of FIG. 8, and/or storage medium 900 of FIG. 9 in conjunction with storage of information on any of client data stores 1108 and/or server data stores 1110.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor circuit; and
a storage medium comprising instructions for execution by the processor circuit to receive a request to write data to a file at a specified offset, determine a stripe identifier (ID) based on the specified offset according to a harmonic-resistant striping order, and initiate a write procedure to cause the data to be written to a stripe of the file, the stripe corresponding to the stripe ID.

2. The apparatus of claim 1, the harmonic-resistant striping order arranged to automatically allocate new stripes to the file at periodic file size intervals.

3. The apparatus of claim 2, the harmonic-resistant striping order arranged to allocate a new set of stripes to the file in response to the file reaching a threshold size and to initially route a disproportionately large fraction of new portions of the file to the set of newly allocated stripes.

4. The apparatus of claim 1, the storage medium comprising instructions for execution by the processor circuit to obtain the stripe ID from a harmonic-resistant striping table specifying the harmonic-resistant striping order.

5. The apparatus of claim 4, the storage medium comprising instructions for execution by the processor circuit to determine an index value based on the specified offset and obtain the stripe ID from the harmonic-resistant striping table based on the index value.

6. The apparatus of claim 5, the storage medium comprising instructions for execution by the processor circuit to determine the index value based on the specified offset and on a maximum stripe count for the file.

7. The apparatus of claim 4, the storage medium comprising instructions for execution by the processor circuit to implement a harmonic-resistant striping table generation algorithm to generate the harmonic-resistant striping table.

8. The apparatus of claim 1, the storage medium comprising instructions for execution by the processor circuit to initiate a stripe creation procedure to create the stripe in response to a determination that the stripe ID does not correspond to an existing stripe of the file.

9. An article, comprising at least one non-transitory computer-readable medium comprising a set of instructions that, in response to being executed on a computing device, cause the computing device to:
receive a request to write data to a file at a specified offset;
determine a stripe identifier (ID) based on the specified offset according to a harmonic-resistant striping order; and
initiate a write procedure to cause the data to be written to a stripe of the file, the stripe corresponding to the stripe ID.

10. The article of claim 9, the harmonic-resistant striping order arranged to automatically allocate new stripes to the file at periodic file size intervals.

11. The article of claim 10, the harmonic-resistant striping order arranged to allocate a new set of stripes to the file in response to the file reaching a threshold size and to initially route a disproportionately large fraction of new portions of the file to the set of newly allocated stripes.

12. The article of claim 9, comprising instructions that, in response to being executed on the computing device, cause the computing device to obtain the stripe ID from a harmonic-resistant striping table specifying the harmonic-resistant striping order.

13. The article of claim 12, comprising instructions that, in response to being executed on the computing device, cause the computing device to:
determine an index value based on the specified offset; and
obtain the stripe ID from the harmonic-resistant striping table based on the index value.

14. The article of claim 13, comprising instructions that, in response to being executed on the computing device, cause the computing device to determine the index value based on the specified offset and on a maximum stripe count for the file.

15. A computer-implemented method, comprising:
receiving a request to write data to a file at a specified offset;
determining, by a processor circuit, a stripe identifier (ID) based on the specified offset according to a harmonic-resistant striping order; and
initiating a write procedure to cause the data to be written to a stripe of the file, the stripe corresponding to the stripe ID.

16. The computer-implemented method of claim 15, the harmonic-resistant striping order arranged to automatically allocate new stripes to the file at periodic file size intervals.

17. The computer-implemented method of claim 16, the harmonic-resistant striping order arranged to allocate a new set of stripes to the file in response to the file reaching a threshold size and to initially route a disproportionately large fraction of new portions of the file to the set of newly allocated stripes.

18. The computer-implemented method of claim 15, comprising obtaining the stripe ID from a harmonic-resistant striping table specifying the harmonic-resistant striping order.

19. The computer-implemented method of claim 18, comprising:
determining an index value based on the specified offset; and
obtaining the stripe ID from the harmonic-resistant striping table based on the index value.

20. The computer-implemented method of claim 19, comprising determining the index value based on the specified offset and on a maximum stripe count for the file.
